(19) United States
(12) Patent Application Publication
(10) Pub. No.: US 2004/0212122 A1
(43) Pub. Date: Oct. 28, 2004

(54) Information recording medium preform, method of manufacturing an information recording medium, and manufacturing apparatus for an information recording medium

(75) Inventors: Atsushi Koyama, Tokyo (JP); Junichi Ide, Tokyo (JP); Mikio Domon, Tokyo (JP); Mamoru Usami, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/829,266

(22) Filed: Apr. 22, 2004

(30) Foreign Application Priority Data
Apr. 24, 2003 (JP) 2003-119143

(51) Int. Cl. B29D 17/00; G11B 7/00

(52) U.S. Cl. 264/107

(57) ABSTRACT

An information recording medium preform is used to manufacture an information recording medium which has a center mounting hole formed in a central part thereof, has at least one type of functional layer formed on a first surface thereof, and for which at least one of recording and reproduction of information is possible. A second cavity that is formed as one of a circular recess and a ring shaped concave and composes part of the center mounting hole on the first surface side is formed in a central part of the first surface of the information recording medium preform. A first cavity that is formed as a recess and composes part of the center mounting hole on a second surface on another side of the information recording medium is also formed in a central part of the second surface of the information recording medium preform.

### BACKGROUND OF THE INVENTION

1. Field of the Invention

This invention relates to an information recording medium preform for manufacturing an information recording medium in a central part of which a center mounting hole is formed, on one surface of which at least one type of functional layer is formed, and which is constructed so that at least one of recording and reproduction of information is possible, to a method of manufacturing an information recording medium that manufactures an information recording medium using this information recording medium preform, and a manufacturing apparatus for an information recording medium.

2. Description of the Related Art

As a method of manufacturing an optical recording medium that manufactures an optical recording medium using an optical recording medium preform as one type of information recording medium preform, Japanese Laid-Open Patent Application No. H10-40584 discloses an optical disc manufacturing method that manufactures an optical disc using a disc substrate (optical recording medium preform) in which a center hole for mounting purposes (hereinafter also referred to as a “center mounting hole”) has not been formed. In this case, the disc substrate (optical recording medium preform) is formed by injection molding in the form of a disc with a larger diameter than the optical disc, with an outer circumferential concave whose internal diameter is equal to the diameter of the optical disc and an inner circumferential concave whose outer diameter is equal to the diameter of the center mounting hole being formed in a rear surface of the disk substrate. When manufacturing an optical disc using this disc substrate, first a first layer (a dielectric layer), a second layer (a metal film), a third layer (a dielectric layer), and a fourth layer (reflective layer) are formed in the stated order on the front surface of the disc substrate. Next, the outer edge part and the central part of the disc substrate in this state are pressed out along the outer circumferential concave and the inner circumferential concave using a press. By doing so, the central part of the disc substrate is removed and the center mounting hole is formed, and at the same time a disc substrate with the same diameter as the optical disc is formed. After this, an overcoat layer is formed on the front surface of the disc substrate that has been punched out, so that the fourth layer is sealed by the overcoat layer, thereby completing the manufacturing of the optical disc.

However, by investigating the above method of manufacturing an optical recording medium, the present inventors discovered the following problem. In the above method of manufacturing, a disc substrate in which the center mounting hole has not been formed is manufactured, the respective layers from the first layer, not shown, to the fourth layer (not shown) are formed on this disc substrate, and after this, as shown in FIG. 14, a central part 100B of the disc substrate 100 is punched out along the inner circumferential concave 106B to form the center mounting hole MHx, and the overcoat layer, not shown, is then formed, thereby completing the manufacturing of the optical recording medium 101. In this case, when the center mounting hole MHx is formed by punching out using a press, a large force is applied to the disc substrate 100 in the pressing direction of the blade edge of the center hole punching out blade, that is, in a direction from a rear surface of the disc substrate 100 towards the front surface. Accordingly, before the blade edge of the center hole punching out blade that presses into the disc substrate 100 reaches the front surface of the disc substrate 100, that is, before the center mounting hole. MHx is punched out and formed, there is the risk that the central part of the front surface of the disc substrate 100 will partially break, forming chips Xa and burrs Xb in the rim of the center mounting hole MHx. For this reason, when the optical recording medium is mounted in a drive apparatus, there are cases where the optical recording medium 101 is eccentrically mounted due to the chips Xa and the burrs Xb, and in such cases, there is the problem that the optical recording medium 101 vibrates during rotation, thereby making it difficult to carry out the recording and reproduction of information correctly.

### SUMMARY OF THE INVENTION

The present invention was conceived in view of the problem described above and it is a principal object of the present invention to provide an information recording medium preform, a method of manufacturing an information recording medium, and a manufacturing apparatus for an information recording medium for which a center mounting hole can be formed without chips and burrs.

To achieve the stated object, an information recording medium preform according to the present invention is used to manufacture an information recording medium which has a center mounting hole formed in a central part thereof, has at least one type of functional layer formed on a first surface thereof, and for which at least one of recording and reproduction of information is possible, with a first cavity that is formed as a recess and composes part of the center mounting hole on a second surface on another side of the information recording medium being formed in a central part of the second surface and a second cavity that is formed as one of a circular recess and a ring shaped concave and composes part of the center mounting hole on the first surface side being formed in a central part of the first surface.

According to this information recording medium preform, the first cavity that composes the second surface side part of the center mounting hole is formed in the central part of the second surface and the second cavity that composes the first surface side part of the center mounting hole is formed in the central part of the first surface, so that when an information recording medium is manufactured, it is possible to form the center mounting hole before the blade edge of a center hole punching out blade reaches the first surface of the information recording medium preform, and as a result, it is possible to reliably avoid the formation of chips and burrs in the rim of the center mounting hole.

A method of manufacturing an information recording medium according to the present invention includes steps of: forming at least one type of functional layer on a first surface of an information recording medium preform, in a central part of the first surface of which a second cavity has been formed as one of a ring shaped concave and a circular recess and in a central part of a second surface that differs to the first surface of which a first cavity has been formed as a recess; connecting the first cavity and the second cavity by pressing in a cylindrical center hole punching out blade into an inner base surface of the first cavity along an inner side surface forming the first cavity to manufacture an information recording medium for which at least one of recording and reproduction of information is possible and in a central part of which a center mounting hole, a first surface side part of which is composed of the second cavity and a second surface side part of which is composed of the first cavity, is formed.

A manufacturing apparatus for forming an information recording medium according to the present invention includes a sputtering apparatus that forms at least one type of functional layer on a first surface of an information recording medium preform, in a central part of the first surface of which a second cavity has been formed as one of a ring shaped concave and a circular recess and in a central part of a second surface that differs to the first surface of which a first cavity has been formed as a recess; a center hole forming device that connects the first cavity and the second cavity by pressing in a cylindrical center hole punching out blade into an inner base surface of the first cavity along an inner side surface forming the first cavity to manufacture an information recording medium for which at least one of recording and reproduction of information is possible and in a central part of which a center mounting hole, a first surface side part of which is composed of the second cavity and a second surface side part of which is composed of the first cavity, is formed.

According to this method of manufacturing an information recording medium and this manufacturing apparatus for an information recording medium that use this information recording medium preform, it is possible to reliably and easily manufacture an information recording medium that can be mounted in a disc drive in a non-eccentric state. As a result, it is possible to provide an information recording medium with reduced vibration and shaking during rotation so that information can be recorded and reproduced properly. In addition, since the center mounting hole can be easily formed by merely punching out the thin part between the base of the second cavity formed in the first surface of the information recording medium preform and the base of the first cavity formed in the second surface, the stress applied to the center hole punching out blade during punching out can be reduced, so that the number of punching out operations can be considerably increased, resulting in a considerable reduction in the manufacturing cost of the information recording medium.

With the information recording medium preform according to the present invention, it is preferable for a corner part between an inner side surface forming the second cavity and the first surface to be beveled. According to this preferred construction, when forming a functional layer or a resin layer (a light transmitting layer) that covers a functional layer by spin coating, for example, it is possible for a resin material or the like to spread out smoothly. Accordingly, according to a method of manufacturing an information recording medium and a manufacturing apparatus for an information recording medium that use this information recording medium preform, it is possible to form a functional layer or resin layer approximately uniformly from a central part of the preform to the outer edge.

With the information recording medium preform according to the present invention, it is preferable for the second cavity to be formed with a depth in a range of 50 to 150 μm inclusive. According to this preferred construction, when forming a light transmitting layer, for example, it is possible for a UV hardening resin to spread out more smoothly.

In addition, with the information recording medium preform according to the present invention, it is preferable for a ring shaped concave whose outer diameter is equal to a diameter of an inner base surface of the first cavity to be formed in the inner base surface of the first cavity. According to this preferred construction, it is possible to make the part at which punching out is carried out by the center hole punching out blade extremely thin. Therefore, according to a method of manufacturing an information recording medium and a manufacturing apparatus for an information recording medium that use this information recording medium preform, it is possible to reduce the stress applied to the information recording medium preform when forming the center mounting hole. Accordingly, the formation of chips and burrs can be avoided more reliably. This means that it is possible to reliably avoid vibration and shaking during rotation, so that it is possible to provide an information recording medium for which information can be recorded and reproduced properly.

In addition, with the information recording medium preform according to the present invention, it is preferable for a temporary center hole with a smaller diameter than an inner base surface of the first cavity to be formed in a central part of the inner base surface of the first cavity. According to this preferred construction, for a method of manufacturing an information recording medium and a manufacturing apparatus for an information recording medium that use this information recording medium preform, when forming the cut and punching out the center mounting hole, for example, it is possible to reliably and easily position the center hole punching out blade with respect to the information recording medium preform. Accordingly, since it is possible to form the cut and the center mounting hole with little eccentricity, it is possible to provide an information recording medium with reduced vibration and shaking during rotation so that information can be recorded and reproduced properly.

Also, with the information recording medium preform according to the present invention, it is preferable for a cylindrical ring whose outer diameter is smaller than the center mounting hole and whose inner diameter is equal to or larger than the diameter of the temporary center hole, and whose central axis matches or approximately matches a center of the temporary center hole to be formed so as to protrude from the first surface. According to this preferred construction, by dripping resin along an outer circumferential surface of the cylindrical ring, it is possible to drip the required amount of resin at a position closer to the center of the information recording medium preform than the hole diameter of the center mounting hole without the resin leaking into the temporary center hole. Accordingly, for a method of manufacturing an information recording medium and a manufacturing apparatus for an information recording medium that use this information recording medium preform, when a film of resin is applied by spin coating, it is possible to make the thickness distribution of the applied film of resin more uniform.

It should be noted that the disclosure of the present invention relates to a content of Japanese Patent Application 2003-119143 that was filed on 24 Apr. 2003 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view showing the construction of an optical recording medium according to an embodiment of the present invention;

FIG. 2 is a cross-sectional view showing the construction of a preform according to an embodiment of the present invention;

FIG. 3 is a cross-sectional view showing the periphery of a circular recess and a ring shaped concave in the preform;

FIG. 4 is a cross-sectional view showing the periphery of a rim of the center hole of the optical recording medium;

FIG. 5 is a block diagram showing the construction of a manufacturing apparatus for manufacturing an optical recording medium (preform);

FIG. 6 is a cross-sectional view showing a state where a functional layer has been formed on a first surface of the preform;

FIG. 7 is a cross-sectional view showing a state where UV hardening resin has been dripped onto a central part of the preform shown in FIG. 6;

FIG. 8 is a cross-sectional view showing a state where a light transmitting layer has been formed by spreading out the UV hardening resin dripped onto the preform shown in FIG. 7;

FIG. 9 is a cross-sectional view showing a state where a blade edge of a cut forming blade has been pressed into the light transmitting layer of the preform shown in FIG. 8 (a state where a cut has been formed in the light transmitting layer);

FIG. 10 is a cross-sectional view showing a state where a blade edge of the center hole punching out blade has been pressed into the preform shown in FIG. 9;

FIG. 11 is a cross-sectional view showing the preform (optical recording medium) in which the center hole has been formed by punching out;

FIG. 12 is a cross-sectional view showing the periphery of a circular recess and a ring shaped concave in a preform according to another embodiment of the present invention;

FIG. 13 is a cross-sectional view showing the construction of a preform according to yet another embodiment of the present invention; and

FIG. 14 is a cross-sectional view showing the periphery of a center hole of a conventional optical disc (disc substrate).

### DESCRIPTION OF THE PREFERRED EMBODIMENTS

Preferred embodiments of an information recording medium preform, a method of manufacturing an information recording medium, and a manufacturing apparatus for an information recording medium according to the present invention will now be described with reference to an example where an optical recording medium, which is one type of information recording medium for the present invention, is manufactured.

First, the constructions of an optical recording medium 1 manufactured by a method of manufacturing an optical recording medium and an optical recording medium preform (information recording medium preform, hereinafter simply “preform”) ME1 that is manufactured before the optical recording medium 1 will be described with reference to the attached drawings.

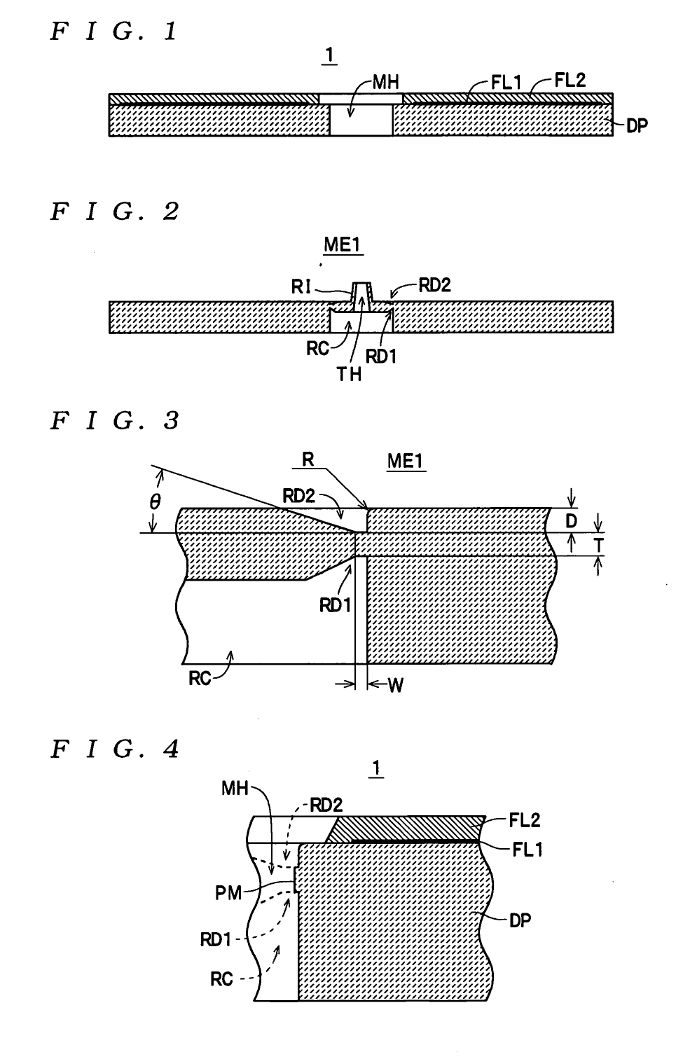

As shown in FIG. 1, the optical recording medium 1 is constructed with a functional layer FL1 and a light transmitting layer FL2 formed in that order on a first surface (the upper surface in FIG. 1 and the “formation surface” for the functional layers) of a disc-like substrate DP. In this case, the disc-like substrate DP can be formed of a thermoplastic resin (as one example, polycarbonate) in a disc-like shape with a thickness of around 1.1 mm and a diameter of around 120 mm, for example. A center mounting hole (hereinafter referred to as the “center hole”) MH with a diameter of around 15 mm is formed in the center of the disc-like substrate DP, and minute convexes and concaves, such as grooves, are formed in a recording area on the first surface of the disc-like substrate DP. On the other hand, the functional layer FL1 is composed of various kinds of thin films, such as a reflective layer, a second dielectric layer, a phase change layer, and a first dielectric layer, that are successively formed in that order from the disc-like substrate DP side. The functional layer FL2 functions as a protective layer (cover layer) that protects the functional layer FL1 and allows a laser beam to pass when recording data is being recorded or reproduced. This functional layer FL2 can be formed, for example, by applying a UV hardening resin that transmits light onto the entire first surface (the entire surface of the functional layer FL1) of the disc-like substrate DP by spin coating and then hardening the resin.

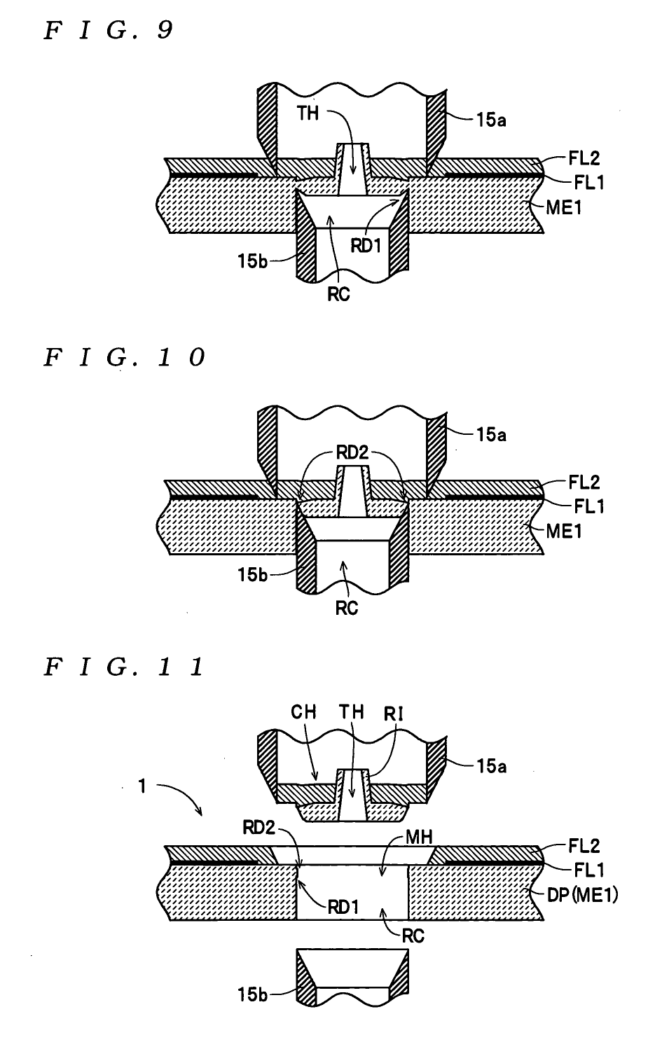

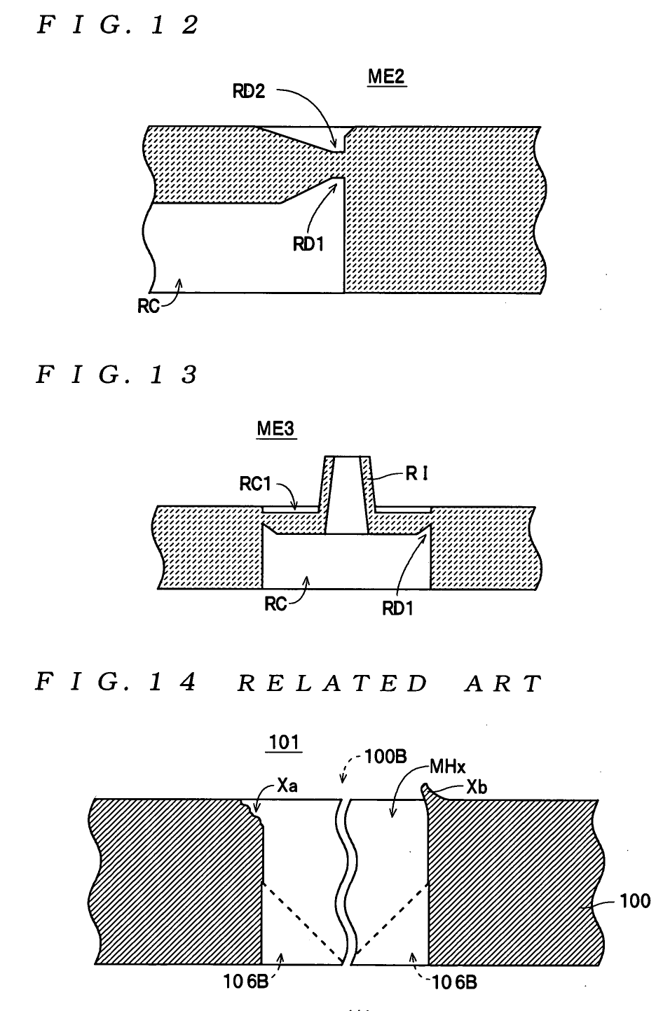

On the other hand, the preform ME1 shown in FIG. 2 is a member that is used for manufacturing an optical recording medium and is manufactured before the optical recording medium 1. The preform ME1 is formed in a disc-like shape with a thickness of around 1.1 mm and a diameter of around 120 mm, and composes the disc-like substrate DP of the completed optical recording medium 1. A circular recess RC that is formed as a recess and forms part (a “second surface side part” for the present invention) of the center mounting hole MH when an inner base surface thereof is punched out during the manufacturing of the optical recording medium 1 is formed in a second surface (the lower surface in FIG. 1) of the preform ME1 and a ring shaped concave RD2 that is groove-like in form and composes another part (a “first surface side part” for the present invention) of the center mounting hole MH when the inner base surface of the circular recess RC has been punched out is formed in the first surface (the upper surface in FIG. 1) of the preform ME1. In this case, the circular recess RC corresponds to the first cavity for the present invention and as shown in FIG. 3, a ring shaped concave RD1 is formed in an outer edge of an inner base surface thereof. This ring shaped concave RD1 is formed so that its outer diameter is the same as the diameter of the inner base surface of the circular recess RC. Also, as shown in FIG. 2, a temporary center hole TH with a smaller diameter than the circular recess RC is formed in a central part of the inner base surface of the circular recess RC. This temporary center hole TH is used to position a cut forming blade 15a and a center hole punching out blade 15b (see FIG. 9) with respect to the preform ME1 when punching out and forming the center mounting hole MH during the manufacturing of the optical recording medium 1. During stacking and transportation of the preform ME1, a stacking pole and chucking apparatus, not shown, are inserted through this hole. In this case, the diameter of the temporary center hole TH in the preform ME1 is set at at least 2 mm, and preferably at at least 3 mm (as one example, at 5 mm).

The ring shaped concave RD2 corresponds to a second cavity for the present invention, and as shown in FIG. 3, is formed as a concave with an inner side surface on a central part side of the ring shaped concave RD2 being tapered (as one example, the slope angle θ is 20°) and an inner side surface (a surface that will form an inner wall surface of the center mounting hole MH) on an outer edge side being perpendicular or almost perpendicular to a planar direction of the preform ME1. This ring shaped concave RD2 is formed with a depth D (a height from the base of the ring shaped concave RD2 to the first surface of the preform ME1) of around 100 μm, for example. In this case, if the depth D of the ring shaped concave RD2 is too shallow, there is the risk of chips and burrs being produced in the rim of the center hole MH when the center hole MH is cut out as described later. When spin coating with a UV hardening resin during formation of the light transmitting layer FL2, the UV hardening resin spreads out towards an outer edge so as to pass beyond the ring shaped concave RD2, so that if the depth D of the ring shaped concave RD2 is too deep, it becomes difficult for the UV hardening resin to flow smoothly and there is the risk of it becoming difficult to form the light transmitting layer FL2 with a uniform thickness across the entire recording layer. Accordingly, the depth D of the ring shaped concave RD2 should preferably be set in a range of 50 μm to 150 μm inclusive. Also, the width W of a base of the ring shaped concave RD2 in the preform ME1 is set, as one example, at 50 μm.

In this case, it is preferable to make the thickness T between the inner base surface of the circular recess RC and the base of the ring shaped concave RD2 thin so as to reduce the stress applied to the preform ME1 when the inner base surface of the circular recess RC is punched out during the manufacturing of the optical recording medium 1 (i.e., when the center mounting hole MH is formed). However, if the thickness T is too thin, there is the risk of accidental breakage during transportation and the like of the preform ME1. Accordingly, the thickness T between the inner base surface of the circular recess RC and the base of the ring shaped concave RD2 should preferably be set in a range of 10 to 300 μm inclusive (as one example, at 100 μm). In addition, a corner part between an inner side surface of the outer edge side that forms the ring shaped concave RD2 and the first surface of the preform ME1 is beveled so as to be arced in cross-section (as one example, an arc with a radius of 50 μm). In this case, if this corner part is not beveled (and is in angular state), there is the risk of the UV hardening resin not spreading out smoothly during spin coating when forming the light transmitting layer FL2. Also, in a state where this corner part is too beveled, there is the risk that when the completed optical recording medium 1 is chucked to a recording/reproducing apparatus, the optical recording medium 1 will rattle so that recording data cannot be properly recorded and reproduced. Accordingly, it is preferable for this corner part to be beveled with a radius of 10 to 100 μm inclusive.

Also, as shown in FIG. 2, a cylindrical ring RI is formed in the first surface (the upper surface in FIG. 2) of the preform ME1, with a central axis of the cylindrical ring RI being set so as to match (one example of an “approximately match”) the center of the temporary center hole TH. That is, the cylindrical ring RI is concentric with the temporary center hole TH. In the present embodiment, the inner diameter of the cylindrical ring RI is set equal (a diameter of 4 mm) to the hole diameter of the temporary center hole TH, with the cylindrical ring RI being formed so as to protrude from the rim of the temporary center hole TH. When the central part of the preform ME1 is punched out by a pressing process to form the center mounting hole MH, the cylindrical ring RI is simultaneously punched out. Accordingly, at a maximum, the outer diameter of the cylindrical ring RI needs to be set equal to or smaller than the diameter of the center mounting hole MH (15 mm or below). When the resin is applied onto the first surface of the preform ME1 by spin coating, it is necessary to drip the resin from a nozzle near the outer circumferential surface of the cylindrical ring RI. When doing so, it was found from experimentation that to apply the resin approximately uniformly and suppress the fluctuations in the thickness of the resin film to within 5 μm or so in the recording area, at least, it is necessary to drip the resin in a range with a diameter of around 10 mm from a center of the preform ME1. It was also found from experimentation that to apply the resin even more uniformly and suppress the fluctuations in the thickness of the resin film to within 3 μm or so in the recording area, it is necessary to drip the resin in a range with a diameter of around 7 mm from the center of the preform ME1. Accordingly, the outer diameter of the cylindrical ring RI is set at 10 mm or smaller, and preferably at 7 mm or smaller. For the preform ME1 according to the present embodiment, as one example the outer diameter of the cylindrical ring RI is set at 6 mm.

To make it possible to drip the required amount of resin and also to prevent the dripped resin from entering the temporary center hole TH and to reduce fluctuations in the thickness of the resin in the recording layer, the distance the cylindrical ring RI protrudes from the first surface of the preform ME1 needs to be set at 0.5 mm or above, and when tolerance is considered, should preferably be set at 1 mm or above. For the preform ME1 according to the present embodiment, as one example, the distance protruded by the cylindrical ring RI is set at 3 mm. Also, for the preform ME1, parts aside from the central part that is punched out by the pressing process are formed the same as the corresponding parts of the optical recording medium 1. Accordingly, fine convexes and concaves, such as grooves, are formed in the recording area on the first surface of the preform ME1.

Next, the construction of a manufacturing apparatus 11 that manufactures the optical recording medium 1 will be described with reference to the drawings.

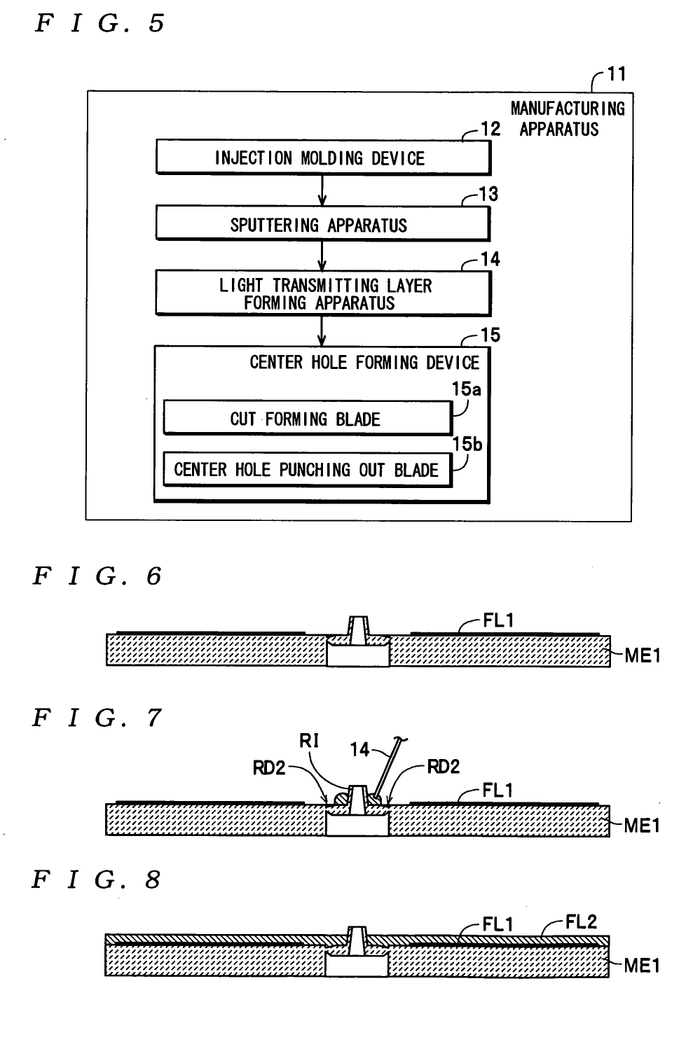

As shown in FIG. 5, the manufacturing apparatus 11 is composed of an injection molding device 12, a sputtering apparatus 13, a light transmitting layer forming apparatus 14, and a center hole forming device 15. As one example, the injection molding device 12 is composed of a mold construction, not shown, with a fixed mold and a movable mold that can approach and move away from the fixed mold, and by injecting melted resin into a cavity formed between the two molds when the molds are closed, the preform ME1 described above is injection molded. The sputtering apparatus 13 forms the functional layer FL1 by forming various recording material layers in order in the recording area of the preform ME1. The light transmitting layer forming apparatus 14 spin coats a UV hardening resin, for example, so as to cover the functional layer FL1 formed on the preform ME1 and then carries out irradiation with UV rays to harden the resin, thereby forming the light transmitting layer FL2 on the functional layer FL1.

As shown in FIG. 9, the center hole forming device 15 is composed of the cut forming blade 15a, the center hole punching out blade 15b, and a moving mechanism, not shown, for moving these blades up and down. The cut forming blade 15a is formed with an overall cylindrical shape, and is formed so that at 16 mm, for example, the diameter of the blade edge is larger than the diameter of the center hole MH. The center hole punching out blade 15b is also formed with an overall cylindrical shape, and is formed so that the diameter of the blade edge is equal to the diameter of the center hole MH (in this case, 15 mm). It should be noted that the actual center hole forming device 15 is equipped with a positioning projection for engaging the temporary center hole TH from the front surface side of the preform ME1 and positioning the cut forming blade 15a with respect to the preform ME1, a positioning projection for engaging the temporary center hole TH from the rear surface side of the preform ME1 and positioning the center hole punching out blade 15b, and an ultrasonic generator or the like for causing the cut forming blade 15a and the center hole punching out blade 15b to vibrate ultrasonically, but for ease of understanding the present invention, these components are not shown and description of such has been omitted.

Next, the method of manufacturing the optical recording medium 1 will be described with reference to the drawings.

When manufacturing the optical recording medium 1, first, the preform ME1 is manufactured by the injection molding device 12. At this time, a stamper in whose surface a pattern for forming minute convexes and concaves, such as grooves, is formed is set in the fixed mold of the injection molding device 12 and then the movable mold is moved by the driving means towards the fixed mold to close the mold construction. Next, melted resin (as one example, polycarbonate) is injected from an injection nozzle of the injection molding device 12 to fill the cavity (a filling step). Next, a gate cutting process is carried out and then the movable mold is moved away from the fixed mold to manufacture the preform ME1 for the optical recording medium 1 as shown in FIG. 2.

Next, as shown in FIG. 6, the sputtering apparatus 13 forms the functional layer FL1 on the first surface of the optical recording medium 1 by sputtering (a functional layer forming step). Here, the respective layers formed by the sputtering (for example, the reflective layer and a recording layer formed of a phase change material) are formed in the recording area using an inner periphery mask and an outer periphery mask. It should be noted that by using an inner periphery mask with a small diameter, it is also possible to form the functional layer in a part closer to the center than the recording area. Next, the light transmitting layer forming apparatus 14 forms the light transmitting layer FL2 so as to cover the functional layer FL1 by spin coating. At this time, as shown in FIG. 7, UV hardening resin, for example, is directly dripped from the nozzle of the light transmitting layer forming apparatus 14 onto a periphery of an outer circumferential surface of the cylindrical ring RI and after this, the preform ME1 is rotated to cause the UV hardening resin to spread out towards an outer edge of the preform ME1.

At this time, for the preform ME1, the depth D of the ring shaped concave RD2 is set at around 100 μm, and the corner part between an inner side surface on the outer circumference side of the ring shaped concave RD2 and the first surface of the preform ME1 is beveled so as to be arced in cross-section with a radius R of around 50 μm, so that the resin dripped in the periphery of the cylindrical ring RI can smoothly flow (spread out) towards the outer edge. Accordingly, it is possible to apply the resin dripped onto the preform ME1 approximately uniformly from the central periphery of the preform ME1 to the outer edge. After this, the light transmitting layer forming apparatus 14 irradiates the UV hardening resin that has spread out over the preform ME1 with UV rays to harden the resin. By doing so, as shown in FIG. 8, the light transmitting layer FL2 is formed on the first surface of the preform ME1 so as to cover the functional layer FL1 (light transmitting layer forming step).

Next, the center hole forming device 15 punches out and forms the center hole MH in the preform ME1 on which the functional layer FL1 and the light transmitting layer FL2 have been formed. At this point, in a state where the center hole punching out blade 15b has been inserted along the inner side surface that forms the circular recess RC and the blade edge of the cut forming blade 15a has been brought into contact with the first surface side of the preform ME1 (the surface of the light transmitting layer FL2), the cut forming blade 15a and the center hole punching out blade 15b are moved so that both blade edges approach one another. In this way, as shown in FIG. 9, first the cut forming blade 15a is pressed into the light transmitting layer FL2 and when the blade edge has reached the first surface of the preform ME1, a V-shaped cut concave is formed in the light transmitting layer FL2. It should be noted that when the cut is formed in the light transmitting layer FL2 by the center hole forming device 15 and the center hole MH is punched out as described later, it is possible for the blade edges of the cut forming blade 15a and the center hole punching out blade 15b to become closer by only one of the blades moving or by both of the blades moving. In addition, in order to form the cut and the center hole MH smoothly, it is preferable for one or both of the cut forming blade 15a and the center hole punching out blade 15b to be ultrasonically vibrated.

Next, both blade edges of the cut forming blade 15a and the center hole punching out blade 15b are brought closer together, so that as shown in FIG. 10, the blade edge of the center hole punching out blade 15b is pressed into the preform ME1 from the inner base surface of the circular recess RC. At this time, when the blade edge of the center hole punching out blade 15b has reached the base of the ring shaped concave RD2 (before reaching the surface of the preform ME1), the central part of the preform ME1 (a range with a diameter of 15 mm centered on a central axis of the preform ME1) is punched out, so that as shown in FIG. 11, the center hole MH is formed in the preform ME1 so as to connect the circular recess RC and the ring shaped concave RD2, thereby manufacturing the disc-like substrate DP. Accordingly, unlike a conventional disc substrate (optical recording medium preform) and method of manufacturing an optical recording medium where the center mounting hole is formed by pressing in the blade edge of the center hole punching out blade until it reaches the surface of the disc substrate, the center mounting hole MH is formed before the blade edge of the center hole punching out blade 15b reaches the first surface of the preform ME1. This means that when the center hole MH is formed by punching out, partial breakage of a central part of a surface (the first surface) of the preform ME1 is avoided. In the preform ME1, by setting the thickness T between the inner base surface of the circular recess RC and a base of the ring shaped concave RD2 thinly at around 100 μm, it becomes possible to punch out this part with a small force. Accordingly, since the stress applied to the preform ME1 when the center hole MH is formed by punching out is extremely small, it is possible to reliably avoid partial breakages of the central part.

In this manufacturing apparatus 11, the external diameter of the center hole punching out blade 15b in the center hole forming device 15 is set approximately equal to (in reality, a slightly smaller diameter than) the external diameter of the circular recess RC of the preform ME1, so that the part between the inner base surface of the circular recess RC and the base surface of the ring shaped concave RD2 is punched out with approximately the same diameter as the outer diameter of the circular recess RC. Accordingly, as shown in FIG. 4, the center mounting hole MH is formed with only an extremely small punching out mark PM (the extremely small stepped part caused by the difference between the outer diameters of the circular recess RC and the ring shaped concave RD2 and the outer diameter of the center hole punching out blade 15b), and the center mounting hole MH is formed without chips and burrs. It should be noted that in FIG. 4, the amount by which the punching out mark PM protrudes has been exaggerated for ease of understanding the present invention. After this, by causing the center hole forming device 15 to move so that the cut forming blade 15a and the center hole punching out blade 15b move apart, as shown in FIG. 11, a punched out part CH produced by punching out the central part of the preform ME1 is separated from the preform ME1 (the disc-like substrate DP) together with the cut forming blade 15a, thereby completing the manufacturing of the optical recording medium 1.

In this way, according to the preform ME1, by forming the circular recess RC that forms part of the second surface side of the center hole MH in the central part of the second surface and the ring shaped concave RD2 that composes part of the first surface side of the center hole MH in the central part of the first surface, the center hole MH can be punched out before the blade edge of the center hole punching out blade 15b reaches the first surface of the preform ME1, which makes it possible to reliably avoid the situation where chips and burrs are formed at the rim of the center hole MH. Accordingly, an optical recording medium 1 that can be mounted in a drive apparatus in a non-eccentric state can be easily and reliably manufactured. As a result, it is possible to provide an optical recording medium 1 with reduced vibration and shaking during rotation so that the recording and reproduction of information can be carried out properly. In addition, since the center hole MH can be easily formed by merely punching out the thin part between the base of the ring shaped concave RD2 formed in the first surface of the preform ME1 and the base of the circular recess RC (the ring shaped concave RD1) formed in the second surface, the stress applied to the center hole punching out blade 15b during punching out can be reduced, so that the number of punching out operations can be considerably increased, resulting in a considerable reduction in the manufacturing cost of the optical recording medium 1.

Also, according to this preform ME1, since the corner part between the inner side surface forming the ring shaped concave RD2 and the first surface of the preform ME1 is beveled so as to be arced in cross-section, the UV hardening resin can spread out smoothly when forming the light transmitting layer FL2. Accordingly, it is possible to form the light transmitting layer FL2 with an approximately uniform thickness from the central part to the outer edge.

Additionally, according to the optical recording medium 1, the ring shaped concave RD2 is formed with a depth D in a range of 50 to 150 μm inclusive (in this case, 100 μm), so that during formation of the light transmitting layer FL2, the UV hardening resin can spread out more smoothly.

Also, according to the preform ME1, by forming, in the outer circumference of the inner base surface of the circular recess RC, the ring shaped concave RD1 whose outer diameter is the same as the diameter of the inner base surface, the part at which punching out is carried out by the center hole punching out blade 15b can be made extremely thin, so that the stress applied to the preform ME1 when the center hole MH is formed can be reduced. Accordingly, the formation of chips and burrs can be avoided more reliably. This means that it is possible to reliably avoid vibration and shaking during rotation, so that it is possible to provide an optical recording medium 1 for which information can be recorded and reproduced properly.

In addition, according to the preform ME1, by forming, in a central part of the inner base surface of the circular recess RC, the temporary center hole TH with a smaller diameter than the inner base surface, it is possible when cutting into the light transmitting layer FL2 with the cut forming blade 15a and when punching out the center hole MH with the center hole punching out blade 15b to position the blades 15a, 15b reliably and easily with respect to the preform ME1. Accordingly, since it is possible to form the cut and the center mounting hole MH with little eccentricity, it is possible to provide an optical recording medium 1 with reduced vibration and shaking during rotation so that information can be recorded and reproduced properly.

Also, according to the preform ME1, the cylindrical ring RI whose outer diameter is smaller than the center mounting hole MH, whose inner diameter is equal to or larger than the diameter of the temporary center hole TH, and whose central axis approximately matches the center of the temporary center hole TH is formed so as to protrude from the first surface of the preform ME1, so that by dripping resin along the outer circumferential surface of the cylindrical ring RI, it is possible to drip the required amount of resin at a position closer to the center of the preform ME1 than the hole diameter of the center mounting hole MH without the resin leaking into the temporary center hole TH. Accordingly, it is possible to make the thickness distribution of the applied film of resin formed by spin coating more uniform.

It should be noted that the present invention is not limited to the embodiment described above and can be modified as appropriate. For example, although an example of a preform ME1 where the corner part between the inner side surface on the outer edge side forming the ring shaped concave RD2 and the first surface of the preform ME1 is beveled so as to be arced in cross-section with a radius of around 50 μm has been described in the above embodiment, the present invention is not limited to this, and for example, as shown by the preform ME2 shown in FIG. 12, a construction can be used where the corner part between the inner side surface on the outer edge side forming the ring shaped concave RD2 and the first surface of the preform ME2 is beveled with a flat surface. According to this construction, in the same way as the preform ME1 described above, when the light transmitting layer FL2 is formed on the preform ME2, compared to the case when the corner part is angular, it is possible for the UV hardening resin to smoothly spread out, so that the light transmitting layer FL2 can be formed with an approximately even thickness from the central part to the outer edge. It is also possible to bevel the corner part between the inner side surface on the outer edge side forming the ring shaped concave RD2 and the first surface of the preform ME1 so as to be polygonal in cross-section. Also, the values of the slope angle θ of the inner surface forming the ring shaped concave RD2 and the width W of the base in the embodiment described above are merely examples, and the present invention is not limited to such values.

Additionally, although an example where the ring shaped concave RD2 is formed in a central part on the first surface of the preform ME1 is described in the above embodiment of the present invention, the present invention is not limited to this and as shown by the preform ME3 shown in FIG. 13, it is possible to use a construction where a circular recess RC1 formed as a recessed part (another example of a “second cavity” for the present invention) is formed instead of the ring shaped concave RD2 of the preform ME1. By using this construction, in the same way as the preform ME1 described above, the center hole MH is punched out before the blade edge of the center hole punching out blade 15b reaches the first surface of the preform ME3, so that the formation of chips and burrs in the rim of the center hole MH can be reliably avoided. Accordingly, it is possible to easily manufacture an optical recording medium 1 that can be mounted in a disc drive in a non-eccentric state. It is also possible to provide an optical recording medium 1 with reduced vibration and shaking during rotation so that information can be recorded and reproduced properly.

1. An information recording medium preform used to manufacture an information recording medium which has a center mounting hole formed in a central part thereof, has at least one type of functional layer formed on a first surface thereof, and for which at least one of recording and reproduction of information is possible,
wherein a second cavity that is formed as one of a circular recess and a ring shaped concave and composes part of the center mounting hole on the first surface side is formed in a central part of the first surface, and
a first cavity that is formed as a recess and composes part of the center mounting hole on a second surface on another side of the information recording medium is formed in a central part of the second surface.

2. An information recording medium preform according to claim 1, wherein a corner part between an inner side surface forming the second cavity and the first surface is beveled.

3. An information recording medium preform according to claim 1, wherein the second cavity is formed with a depth in a range of 50 to 150 μm inclusive.

4. An information recording medium preform according to claim 1, wherein a ring shaped concave whose outer diameter is equal to a diameter of an inner base surface of the first cavity, is formed in the inner base surface of the first cavity.

5. An information recording medium preform according to claim 1, wherein a temporary center hole with a smaller diameter than an inner base surface of the first cavity, is formed in a central part of the inner base surface of the first cavity.

6. An information recording medium preform according to claim 5, wherein a cylindrical ring whose outer diameter is smaller than the center mounting hole and whose inner diameter is equal to or larger than the diameter of the temporary center hole, and whose central axis matches or approximately matches a center of the temporary center hole is formed so as to protrude from the first surface.

7. A method of manufacturing an information recording medium comprising steps of: forming at least one type of functional layer on a first surface of an information recording medium preform, in a central part of the first surface of which a second cavity has been formed as one of a ring shaped concave and a circular recess and in a central part of a second surface that differs to the first surface of which a first cavity has been formed as a recess; connecting the first cavity and the second cavity by pressing in a cylindrical center hole punching out blade into an inner base surface of the first cavity along an inner side surface forming the first cavity to manufacture an information recording medium for which at least one of recording and reproduction of information is possible and in a central part of which a center mounting hole, a first surface side part of which is composed of the second cavity and a second surface side part of which is composed of the first cavity, is formed.

8. A manufacturing apparatus for forming an information recording medium, comprising:
a sputtering apparatus that forms at least one type of functional layer on a first surface of an information recording medium preform, in a central part of the first surface of which a second cavity has been formed as one of a ring shaped concave and a circular recess and in a central part of a second surface that differs to the first surface of which a first cavity has been formed as a recess;
a center hole forming device that connects the first cavity and the second cavity by pressing in a cylindrical center hole punching out blade into an inner base surface of the first cavity along an inner side surface forming the first cavity to manufacture an information recording medium for which at least one of recording and reproduction of information is possible and in a central part of which a center mounting hole, a first surface side part of which is composed of the second cavity and a second surface side part of which is composed of the first cavity, is formed.
